(19) United States
(12) Patent Application Publication
(10) Pub. No.: US 2006/0285154 A1
(43) Pub. Date: Dec. 21, 2006

(54) Host device, image-forming device, and print system having automatic classification function, and print control method therefor

(75) Inventors: Jeong-sang Kim, Suwon-si (KR); Na-young Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/447,008

(22) Filed: Jun. 6, 2006

(30) Foreign Application Priority Data
Jun. 20, 2005 (KR) 2005-52962

(51) Int. Cl. G06F 3/12

(52) U.S. Cl. 358/1.15; 358/1.13

(57) ABSTRACT

A host device having an automatic classification function, including at least one first application program unit to issue a print command over plural print data for printout, and a print control program unit to input and temporarily store the plural print data, and, if the plural print data is found to be completely inputted, to control the temporarily stored plural print data to be printed in sequential order.

### CROSS-REFERENCE TO RELATED APPLICATION

This application claims the benefit under 35 U.S.C. § 119 of Korean Patent Application No. 2005-52962, filed on Jun. 20, 2005, in the Korean Intellectual Property Office, the disclosure of which is incorporated herein by reference.

### BACKGROUND OF THE INVENTION

1. Field of the Invention

An aspect of the present invention relates to a host device, an image-forming device, and a print system having an automatic sorting function, and a print control method therefor, and, more particularly to a host device, an image-forming device, and a print system having an automatic classification function capable of automatically classifying plural print jobs.

2. Description of the Related Art

In conferences, lectures, forums, or the like to be held with several attendants, it is desirable for persons in charge to prepare documents in advance to be distributed to attendants. As office automation equipment, and, in particular, image-forming devices, such as laser beam printers providing a fast print speed become more advanced, it becomes easier to directly create documents to be distributed to attendants in conferences, lectures, forums, or the like. Since the documents need to be prepared for each of the attendants, more time is required for printing as the number of attendants increases.

Further, if a conventional image-forming device is used to print several different multi-page documents, the first page of each document is printed a number of times equal to the number of desired copies. Thus, a user must classify the printed documents by the amount of pages therein.

In order to eliminate hassles caused by such a manual job, an “automatic classification” function offered by the driver of an image-forming device and a “collate” function offered by an application program have been proposed.

If several multi-page documents are printed with the “automatic classification” or “collate” function applied, one document is printed from the first to the last page, and then another document is printed similarly. Using the “automatic classification” or the “collate” function as above when a document is in one file, a user identifies the first page and combines pages for a document to be given away to an attendant.

However, if a document to be provided to attendants is stored in plural files created in plural application programs or is stored in plural files created in one application program, the “automatic classification” or “collate” function may not be able to automatically classify pages by the number of pages to be distributed to each attendant. Thus, there exists a problem since a user has to perform printouts file by file and manually classify printed pages.

### SUMMARY OF THE INVENTION

An aspect of the present invention has been developed in order to solve the above and/or other drawbacks and problems associated with the conventional arrangement. Another aspect of the present invention is to provide a host device having an automatic classification function, including at least one first application program unit to issue a print command over plural print data for printout, and a print control program unit to input and temporarily store the plural print data, and, if the plural print data is found to be completely inputted, to control the temporarily stored plural print data to be printed in sequential order.

The foregoing and/or other aspects and advantages are substantially realized by providing a print control method, comprising inputting and temporarily storing plural print data; and controlling, if the plural print data is completely inputted, the temporarily stored plural print data to be printed in sequential order.

The foregoing and/or other aspects and advantages are substantially realized by providing an image-forming device, comprising a user input unit to allow for an input of at least one request signal; a storage unit to temporarily store plural print data inputted from a host device if a multi-job classification setting request signal is inputted from the user input unit; a print unit to output the plural print data; and a control unit to control the print unit to print the temporarily stored plural print data in sequential order if a print request signal is inputted from the user input unit.

The foregoing and/or other aspects and advantages are substantially realized by providing an automatic classification method for use with image-forming devices, comprising temporarily storing plural print data inputted from a host device if a multi-job classification setting request signal is inputted; and printing the temporarily stored plural print data in sequential order if a print request signal is inputted.

The foregoing and/or other aspects and advantages are substantially realized by providing a print system having an automatic classification function, comprising a host device to control plural print data to be one by one printed in order; and an image-forming device to receive the plural print data from the host device and printing the plural print data in sequential order by controls of the host device.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram for showing a host device according to a first embodiment of the present invention;

FIGS. 2A and 2B is views for illustrating user interfaces provided by the driver unit of FIG. 1;

FIG. 3 is a block diagram for showing a host device according to a second embodiment of the present invention;

FIG. 4 is a view for illustrating a user interface provided by the print control program of FIG. 3;

FIG. 5 is a block diagram for showing an image-forming device according to another embodiment of the present invention;

FIG. 6 is a flow chart to explain a print control method according to the embodiment shown in FIG. 1;

FIG. 7 is a flow chart for explaining a print control method according to the embodiment shown in FIG. 3; and

FIG. 8 is a flow chart for explaining an automatic classification method for an image-forming device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

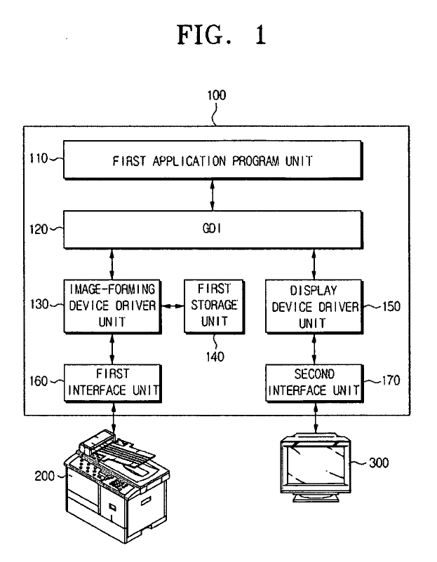

FIG. 1 is a block diagram for showing a host device according to a first embodiment of the present invention. As shown in FIG. 1, a host device 100 is connected to an image-forming device 200 and a display device 300. A driver program in installed in the image-forming device 200 and comprises a print control program unit to control printouts of plural data to be printed (hereinafter, referred to as print data).

The host device 100 comprises a first application program unit 110, a graphic device interface (GDI) unit 120, an image-forming device driver unit 130, a first storage unit 140, a display device driver unit 150, a first interface unit 160, and a second interface unit 170. The first application program unit 110 interfaces with the image-forming device driver unit 130 and the display device driver unit 150 through the GDI unit 120 when a user input signal is inputted through a user interface. The first application program unit 110 refers to a general application program, such as word-processing software programs. The first application program unit 110 enables users to create new print data, to read created print data, and to send a print command for printout of the created print data to the image-forming device driver unit 130. As such, the first application program unit 110 sends the image-forming device driver unit 130 the print data together with the print data.

The GDI unit 120 supports interface between the image-forming device driver unit 130 and the display device driver unit 150. For example, the GDI unit 120 sends print commands and print data from the first application program unit 110 to the image-forming device driver unit 130.

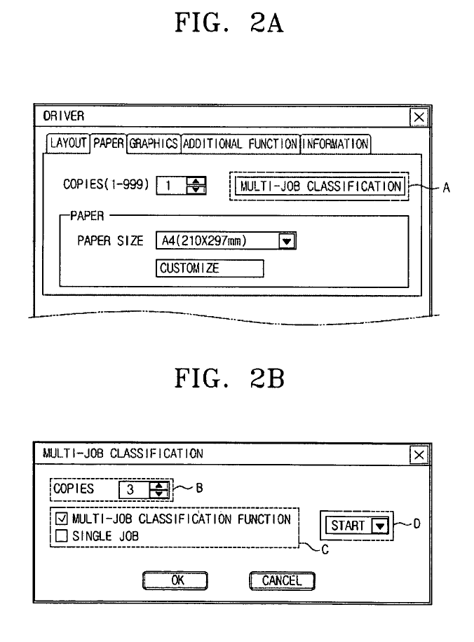

The image-forming device driver unit 130 converts the print commands and print data inputted from the first application program unit 110 into data in a format that the image-forming device 200 can recognize. The image-forming device driver unit 130 provides a user with a user interface on which the user may set basic driving conditions of the image-forming device 200 (i.e., options such as paper size, print quality, the number of copies for printout, etc.). Further, the image-forming device driver unit 130 provides a user with a user interface that further offers the user an option to set or release a multi-job classification function, an option of setting the start and finish of print data to which the multi-job classification function is applied, and an option of setting the number of copies for printout at the time the multi-job classification function is applied thereto. With reference to FIG. 2, description of the user interface offered by the image-forming device driver unit 130 will be provided below.

The image-forming device driver unit 130 temporarily stores the plural print data inputted with the multi-job classification function settings in the first storage unit 140, and, if the plural print data is completely inputted, controls the image-forming device 200 to consecutively, and, in collation, print the plural print data temporarily stored in the first storage unit 140. Further, if the image-forming device 200 terminates the printing of the plural print data, the image-forming device driver unit 130 controls the deleting of the plural print data temporarily stored in the first storage unit 140. Thus, the limited storage space of the first storage unit 140 may be efficiently used.

If plural print data are inputted with the multi-job classification function settings through GDI unit 120 from the first application program unit 110 to the image-forming device driver unit 130, the first storage unit 140 temporarily stores the plural print data inputted under controls of the image-forming device driver unit 130.

The display device driver unit 150 converts the data for display, which are inputted from the GDI unit 120, into a format displayable on the display device 300. The first interface unit 160 may be connected to the display device 300, so as to send to the display device 300 the data for display signal-processed by the display device driver unit 150.

FIGS. 2A and 2B are views to illustrate user interfaces offered by the driver unit shown in FIG. 1. As shown, the image-forming device driver unit 130 provides a user with user interfaces having diverse options in order to interface with the user, and enables the user to set the multi-job classification function through the user interfaces. In particular, as shown in FIG. 2A, the image-forming device driver unit 130 comprises a multi-job classification button A to allow a user to set detailed options for settings of the multi-job classification function through the user interfaces.

If the multi-job classification button A is selected, detailed options are displayed for settings of the multi-job classification function as shown in FIG. 2B. When the multi-job classification function is activated, the detailed options for the function include an option B to set the number of copies for printout, an option C to select the multi-job classification function, and an option D to set the start or finish time of print data to which the multi-job classification function is applied.

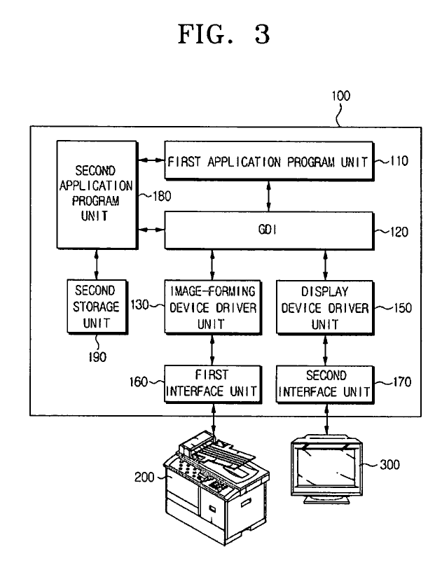

FIG. 3 is a block diagram to show a host device according to a second embodiment of the present invention. As shown in FIG. 3, the host device 100 is similar in structure to the host device 100 shown in FIG. 1 except that an application program used separately from a driver program, as a program to control the image-forming device 200 for printouts is installed.

As shown in FIG. 2, the host device 100 comprises the first application program unit 110, the GDI unit 120, the image-forming device driver unit 130, the display device driver unit 150, the first interface unit 160, the second interface unit 170, a second application program unit 180, and a second storage unit 190. The GDI unit 120 supports interfaces among the second application program unit 180, the image-forming device driver unit 130, and display device driver unit 150. For example, the GDI unit 120 sends print commands and print data from the second application program unit 180 to the image-forming device driver unit 130.

In the present embodiment, the image-forming device driver unit 130 provides only the functions of a general driver program which convert print data into a format the image-forming device 200 recognizes.

The second application program unit 180 is a type of an application program to control the corresponding first application program unit 110 to perform execution with plural print data selected by a user. Here, there is no need for the plural print data selected by a user to be data created in one application program since the plural print data may be created in diverse application programs. Therefore, the second application program unit 180 runs the first application program unit 110 corresponding to the plural print data.

The second application program unit 180 creates a list of multiple jobs for the plural print data selected by a user. If the first application program unit 110 runs with the print data, the second application program unit 180 controls the executed print data to be temporarily stored in the second storage unit 190.

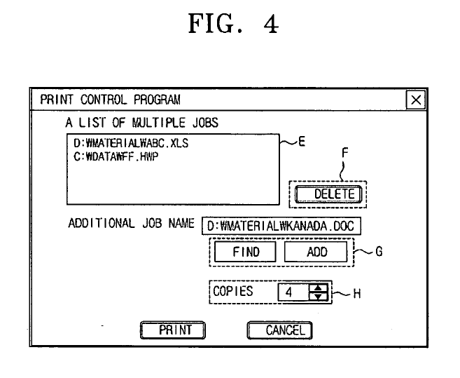

The second application program unit 180 provides a user interface to support an interface with a user. The user interface from the second application program unit 180 is provided with options to add or delete print data to and from the list of multiple jobs, options to give print commands over the print data on the list of multiple jobs, etc. With reference to FIG. 4, a description of the user interface of the second application program unit 180 will be provided below.

If the print data added to the list of multiple jobs is completely executed and all the print data is temporarily stored in the second storage unit 190, the second application program unit 180 controls the image-forming device 200 to print the plural print data by collation. Further, if the image-forming device 200 completely terminates the printout, the second application program unit 180 may delete the plural print data temporarily stored in the second storage unit 190, thereby securing storage space in the second storage unit 190. If the second application program unit 180 runs the first application program unit 110 to execute with the plural print data the second storage unit 190 temporarily stores the plural print data run by the controls of the second application program unit 180.

FIG. 4 is a view illustrating a user interface provided by the print control program unit of FIG. 3. The user interface comprises a multi-job list area E to display a list of multiple jobs in order for a user to check print data for printout, a delete button F used when a user deletes unnecessary print data from the list of multiple jobs, Find and Add buttons G to allow for an adding of new print data to a list of multiple jobs, and an option button H to allow for a setting of the number of copies for printout for the list of multiple jobs. As above, a user may easily add or delete print data to or from the list of multiple jobs through the user interface provided by the second application program unit 180.

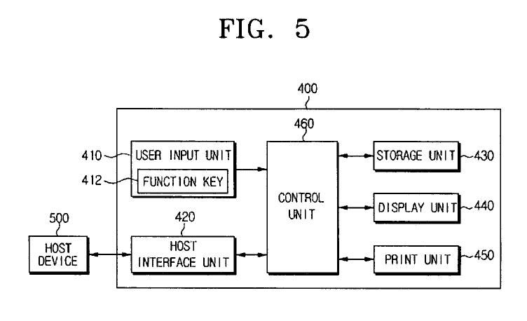

FIG. 5 is a block diagram showing an image-forming device according to another embodiment of the present invention. As shown in FIG. 5, an image-forming device 400 comprises a user input unit 410, a host interface unit 420, a storage unit 430, a display unit 440, a print unit 450, and a control unit 460. The user input unit 410 applies at least one request signal resulting from manipulation of the user to the control unit 460. In the present embodiment, a request signal applied from the user input unit 410 includes a multi-job classification setting request signal and a printout request signal. The user input unit 410 is provided with plural function keys 412 for applying at least one request signal. The host interface unit 420 is connectably mounted to a host device 500 so as to provide an interface between the host device 500 and the image-forming device 400, and sends print data from the host device 500 to the image-forming device 400.

If the multi-job classification setting signal is inputted from the user input unit 410, the storage unit 430 temporarily stores plural print data inputted from the host device 500 under the controls of the control unit 460. The display unit 440 displays information to be served to a user by the controls of the control unit 460. The display unit 440 may display a list of print data in order for a user to check print data. The print unit 450 prints the plural print data with collation under the controls of the control unit 460. The control unit 460 controls overall functions of the image-forming device 400. That is, the control unit 460 controls inputs and outputs of the user input unit 410, the host interface unit 420, the storage unit 430, the display unit 440, and the print unit 450. If the print request signal is inputted from the user input unit 410, the control unit 460 controls the print unit 450 to print the plural print data temporarily stored in the storage unit 430 in order.

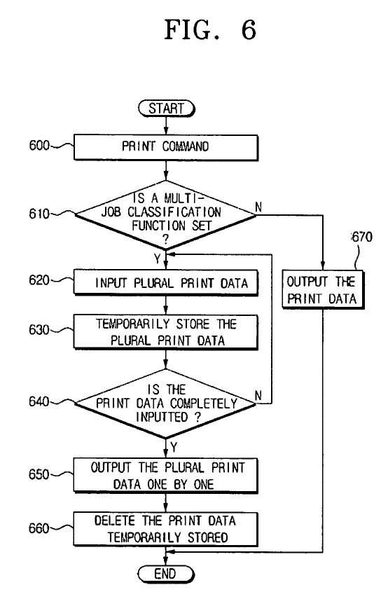

FIG. 6 is a flow chart to explain a print control method according to an embodiment of the present invention. If the first application program unit 110 issues a print command, print data and a print command therefor are sent to the image-forming device driver unit 130 through the GDI unit 120 from the first application program unit 110 (600). A user then sets a multi-job classification function through a user interface provided by the image-forming device driver unit 130. The image-forming device driver unit 130 controls the print data from the first application program unit 110 to be temporarily stored in the first storage unit 140 when the multi-job classification function is set. That is, operations 610 to 630 temporarily store in the first storage unit 140 from print data inputted with the option D set to “start” up to print data inputted with the option D set to “finish,” wherein the option D shown in FIG. 2 sets the start and finish of the print data to which the multi-job classification function is applied.

If the print data is completely inputted, that is, if the print data with the option D set to “finish” is inputted, the image-forming device driver unit 130 controls the plural print data temporarily stored in the first storage unit 140 to be printed in collation, wherein the option D is to set the start and finish of the print data to which the multi-job classification function is applied. A print control signal from the image-forming device driver unit 130 is sent to the image-forming device 200 through the first interface unit 160. The image-forming device 200 prints the plural print data in order according to the print control signal from the image-forming device driver unit 130 (operations 640 to 650). Next, if the printout is terminated, the image-forming device driver unit 130 controls the plural print data temporarily stored in the first storage unit 140 to be deleted, thereby securing a storage space in the first storage unit 140 (660).

If, in operation 610, it is determined that the multi-job classification function is not set, the image-forming device driver unit 130 controls a printout job to be performed according to a general printout job (670).

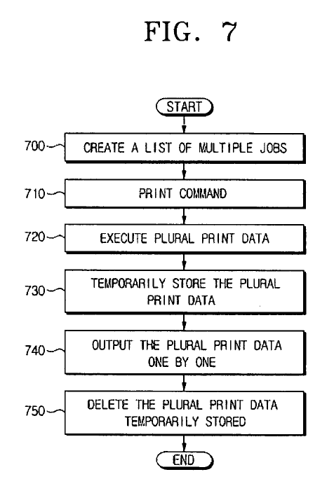

FIG. 7 is a flow chart to explain a print control method according to a second embodiment of the present invention. As shown in FIG. 7, a user adds plural print data for multiple jobs to a list of multiple jobs through a user interface provided by the second application program unit 180. The second application program unit 180 creates a list of multiple jobs for plural print data selected by a user. The list of multiple jobs is displayed on the user interface as shown in FIG. 4 (700). If a user gives a print command through the user interface, the second application program unit 180 runs the corresponding first application program unit 110 to execute with the print data contained in the list of multiple jobs (operations 710 to 720). If the first application program unit 110 runs with the plural print data, the second application program unit 180 controls the executed print data to be temporarily stored in the second storage unit 190 (730).

If all the print data contained in the list of multiple jobs are executed and stored, the second application program unit 180 sends the print control signal in order for the plural print data to be one by one printed in order. The print control signal from the second application program unit 180 is sent through the GDI unit 120 to the image-forming device driver unit 130, is converted by the image-forming device driver unit 130 into a format that the image-forming device 200 can recognize, and is then sent through the first interface unit 160 to the image-forming device 200 (740).

Next, if the printout is terminated, the second application program unit 180 controls the plural print data temporarily stored in the second storage unit 190 to be deleted, thereby securing a storage space in the second storage unit 190 (750).

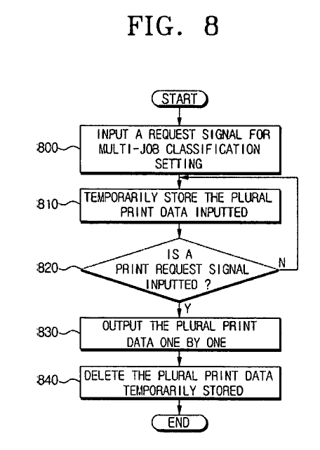

FIG. 8 is a flow chart to explain an automatic classification method for an image-forming device according to an embodiment of the present invention. When a user manipulates the function keys 412 of the user input unit 410 to perform a print job with the multi-job classification function applied, the user input unit 410 sends a request signal to the control unit 460 for multi-job classification setting (800). Before the request signal is input for the multi-job classification setting, the print data is not stored. After the request signal is inputted for the multi-job classification setting, the control unit 460 controls the print data from the host device 500 to be temporarily stored in the storage unit 430 (810).

If a user manipulates the function keys 412 of the user input unit 410 to perform a print job for plural print data, a print request signal is inputted to the control unit 460 from the user input unit 410. If the print request signal is inputted, the control unit 460 controls the print unit 450 to print the plural print data that is temporarily stored in the storage unit 430 in sequential order (operations 820 to 830).

Next, once the print unit 450 terminates the print job, the control unit 460 controls the plural print data temporarily stored in the storage unit 430 to be deleted, thereby securing a storage space in the storage unit 430 (840).

As is stated above, aspects of the present invention may automatically classify and print documents separated in several files by using any of the image-forming device driver unit 130, second application program unit 180, and image-forming device 400. Further, as is aforementioned, the host device, image-forming device, and print system having the automatic classification function, and the print control method=provide a function to control diverse types of documents to be printed in order, thereby having an advantage capable of reducing hassles resulting from jobs of re-classifying the printout.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A host device having an automatic classification function, comprising:
at least one first application program unit to issue a print command over plural print data for printout; and
a print control program unit to input and temporarily store the plural print data, and, if the plural print data is found to be completely inputted, to control the temporarily stored plural print data to be printed in sequential order.

2. The host device as claimed in claim 1, wherein the print control program unit is a driver unit for use with an image-forming device.

3. The host device as claimed in claim 2, wherein the driver unit comprises a user interface provided with an option to allow for a setting or releasing of a multi-job classification function, an option to allow for a setting of a start and a finish of print data to which the multi-job classification function is applied, and an option to allow for a setting of the number of copies for printout when the multi-job classification function is applied.

4. The host device as claimed in claim 1, wherein the print control program is a second application program unit to control printout over the plural print data.

5. The host device as claimed in claim 4, wherein the second application program unit inputs a list of the plural print data from a user through a user interface.

6. The host device as claimed in claim 5, wherein the second application program unit causes the first application program unit to run with the plural print data based on the inputted list of the plural print data.

7. A print control method, comprising:
inputting and temporarily storing plural print data; and
controlling, if the plural print data is completely inputted, the temporarily stored plural print data to be printed in sequential order.

8. The print control method as claimed in claim 7, further comprising inputting a list of the plural print data from a user.

9. The print control method as claimed in claim 8, wherein the storing comprises:
executing the plural print data based on the inputted list of the plural print data; and
temporarily storing the executed plural print data.

10. An image-forming device, comprising:
a user input unit to allow for an input of at least one request signal;
a storage unit to temporarily store plural print data inputted from a host device if a multi-job classification setting request signal is inputted from the user input unit;
a print unit to output the plural print data; and
a control unit to control the print unit to print the temporarily stored plural print data in sequential order if a print request signal is inputted from the user input unit.

11. The image-forming device as claimed in claim 10, further comprising a display unit to display a list of the plural print data.

12. An automatic classification method for use with image-forming devices, comprising:
temporarily storing plural print data inputted from a host device if a multi-job classification setting request signal is inputted; and
printing the temporarily stored plural print data in sequential order if a print request signal is inputted.

13. The automatic classification method as claimed in claim 12, further comprising displaying a list of the temporarily stored plural print data.

14. A print system having an automatic classification function, comprising:
a host device to control plural print data to be one by one printed in order; and
an image-forming device to receive the plural print data from the host device and printing the plural print data in sequential order by controls of the host device.

15. The print system as claimed in claim 14, wherein the host device has:
a first application program unit to issue a print command over the plural print data; and
a driver unit to temporarily store print data inputted from the first application program, and, if the print data is completely inputted, to control the temporarily stored plural print data to be one by one printed in order.

16. The print system as claimed in claim 14, wherein the host device has:
a first application program unit to issue a print command over the plural print data; and
a second application program unit to cause the first application program to execute with plural print data selected by a user, to temporarily store the executed data, and to control the temporarily stored plural print data to be printed in sequential order.

17. A host device having an automatic classification function, comprising:
at least one first application program unit to issue a print command to initiate a printing operation for at least first and second documents; and
a printer driver for use with an image forming device to input and temporarily store the first and second documents, and, if the first and second documents are found to be completely inputted, to control the temporarily stored first and second documents to be printed, with the printing of the first document to be completed before the printing of the second document.

18. The host device as claimed in claim 17, wherein the printer driver comprises:
a user interface provided with an option to allow for a setting or releasing of a multi-job classification function;
an option to allow for a setting of a start and a finish of print data to which the multi-job classification function is applied; and
an option to allow for a setting of the number of copies for printout when the multi-job classification function is applied.

19. The host device as claimed in claim 17, wherein the printer driver comprises a second application program unit to control printout over the first and second documents.

20. The host device as claimed in claim 19, wherein the second application program unit inputs a list of the first and second documents from a user through a user interface, and causes the first application program unit to issue the print command based on the inputted list of the first and second documents.
